(19) United States
(12) Patent Application Publication
(10) Pub. No.: US 2008/0034444 A1
(43) Pub. Date: Feb. 7, 2008

(54) SYSTEM, NETWORK ENTITY, TERMINAL AND METHOD FOR PROVIDING DIGITAL RIGHTS MANAGEMENT OF CLIENT APPLICATIONS

(75) Inventor: Robert K. Sears, Palo Alto, CA (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation, Espoo (FI)

(21) Appl. No.: 11/462,612

(22) Filed: Aug. 4, 2006

(51) Int. Cl. G06F 17/30; H04N 7/16

(52) U.S. Cl. 726/29

(57) ABSTRACT

A system for providing digital rights management of content, such as an electronic game, includes a network entity and a client. The network entity is capable of sending an authentication challenge randomly identifying at least a portion of content stored in memory of a client. For example, the network entity can be capable of sending an authentication challenge randomly identifying at least one location in memory of the client. In response to the authentication challenge, the client is capable of generating an authentication code based upon the content identified by the authentication challenge, such as by generating an authentication code based upon the content stored at the identified locations in memory of the client. The client can then return the authentication code to the network entity, which can thereafter authenticate the client based upon the authentication code.

### FIELD OF THE INVENTION

The present invention generally relates to systems and methods of operating a client application and, more particularly, relates to systems and methods of providing digital rights management of electronic games.

### BACKGROUND OF THE INVENTION

Electronic games have become a widespread entertainment feature and are well known in the state of the art as video games or gaming machines. To increase the fun of the game many video games offer the option to play against a computer or against other persons. Some games can be played in a one, two or more player mode, to provide virtual adventures, or to economize expensive gaming equipment. There are actually many different gaming simulations such as sports games, car races, strategy games and even war games available. The attraction of some of these games resides in the fact that the games can be played “online” via networks such as the Internet, enabling remote users to access and play different games against each other, while being in different rooms, homes, towns, countries or even continents.

With the proliferation and expansion of digital content including electronic games, challenges are repeatedly arising with respect to controlling the creation, distribution, sale, marketing and consumption of copyrighted digital content. In this regard, recently developments indicate that producers of digital content are under pressure and have a desire to profit from these new developments and reduce their vulnerability to the risk. However, the risks are now more obvious to content producers than the potential benefits of the new technologies.

Copyright protection systems of the pre-digital age consisted of legal mechanisms to prosecute individuals and groups that ran large-scale illegal reproduction facilities for profit. Since intellectual property pirates in the pre-digital age needed physical assets to reproduce the physical media of books, music, video or the like, they were subject to traditional law enforcement techniques. The added complications imposed by distribution of these contraband copies made these pirates even more vulnerable to detection. From the consumer's perspective, the illegal copies produced by these pirates were less interesting because quality suffered and the copies were not always promptly available as legitimate copies.

The digital age introduced new risks because flawless copies are now infinitely reproducible and may be transmitted instantly anywhere in the world. There has been a shift from a paradigm where a large number of individuals made a few copies to one where relatively few individuals can make many copies. Currently, legal and regulatory means exist to protect digital content. However, a deterrent is necessary to make the illegal copying and distribution of copyrighted content difficult and traceable. For this reason, the deployment of a trusted end-to-end solution for the management of digital rights is a necessary precursor to digital production, dissemination and consumption of copyrighted content.

Digital rights management (DRM) involves the description, layering, analysis, valuation, trading, and monitoring of an owner's property rights to an asset. DRM covers the management of the digital rights to the physical manifestation of a work (e.g., a textbook) or the digital manifestation of a work (e.g., a Web page). DRM also covers the management of an asset whether the asset has a tangible or an intangible value. Current DRM technologies include languages for describing the terms and conditions for an asset, tracking asset usage by enforcing controlled environments or encoded asset manifestations, and closed architectures for the overall management of the digital rights. Currently, for example, many electronic games are distributed on read-only multimedia cards (MMCs). Gaming systems, then, may include techniques for guarding against illegally duplicated MMCs built into the systems' hardware and firmware such that the gaming systems refuse to consume content from illegally duplicated MMCs. Such DRM techniques, however, have been circumvented by modifying the DRM-enabling technologies of the MMCs and/or the gaming systems themselves. As such, where as current DRM technologies are adequate for protecting against illegal use of copyrighted digital content, these techniques also have drawbacks in that they are capable of being circumvented.

### SUMMARY OF THE INVENTION

In light of the foregoing background, exemplary embodiments of the present invention provide an improved system, client, network entity, method and computer program product for providing digital rights management of content. In accordance with exemplary embodiments of the present invention, a network entity (e.g., game server) controls access to content (e.g., an electronic game) that a client desires to access, such as to interact with the same or a different network entity (e.g., routing server, game server, etc.). To control access to the content, the network entity can, at one or more instances, challenge the client to authenticate itself. In this regard, the network entity can challenge the client to provide, to the network entity, an authentication code generated based upon portions of memory of the client identified by the network entity. The client does not know beforehand the portions of memory the network entity identifies, and in multiple instances of challenging the client, the identified portions of memory can differ from one instance to the next. Thus, exemplary embodiments of the present invention provide a framework for providing digital rights management of content in a dynamic manner based upon information readily available to the client, where such information may otherwise be difficult to manipulate. Also, by challenging the client at a number of different instances by identifying repeatedly differing portion(s) of memory, exemplary embodiments of the present invention can inhibit use of illegally duplicated content since to do so would require the unauthorized client to pre-store the entire memory of the authorized client.

According to one aspect of the present invention, a system is provided for providing digital rights management of content, where the system comprises a network entity and a client. In the context of providing digital rights management of an electronic game, for example, the network entity can comprise a game server, routing server or other network entity in communication with a game server or routing server. The network entity is capable of sending an authentication challenge randomly identifying at least a portion of content stored in memory of a client. For example, the network entity can be capable of sending an authentication challenge randomly identifying at least one location in memory of the client. In the context of a system providing digital rights management of an access-controlled application stored in memory of the client, for example, the network entity can be capable of sending an authentication challenge randomly identifying at least a portion of a read-only memory (ROM) of the client, and at least a portion of the access-controlled application stored in memory of the client.

In response to the authentication challenge, the client is capable of generating an authentication code based upon the content identified by the authentication challenge, such as by generating an authentication code based upon the content stored at the identified locations in memory of the client. For example, the client can generate an authentication code by hashing the content stored at the identified locations in memory of the client. The client can then return the authentication code to the network entity. The network entity can thereafter authenticate the client based upon the authentication code. In the context of providing digital rights management of an access-controlled application adapted to interact with the same or a different network entity, for example, the network entity can be capable of authenticating the client such that the client is thereafter permitted to operate the access-controlled application to interact with the network entity when the client is authenticated. Otherwise, when the client is not authenticated, the client is prevented from operating the access-controlled application to interact with the same or the different network entity. The network entity can be capable of sending an authentication challenge, receiving an authentication code and authenticating the client at a plurality of instances. In such instances, the network entity can be configured such that the content identified by the authentication challenge in at least one instance differs from the content identified by the authentication challenge in at least one other instance.

The network entity can be further capable of mapping at least a portion of the content stored in memory of a known-authorized client. In such instances, the mapped content is associated with at least one location in memory of the known-authorized client where the content is stored. The network entity can be capable of generating a comparison code based upon the mapped content stored at the identified locations in memory of the known-authorized client, such as by hashing the mapped content stored at the identified locations in memory of the known-authorized client. Then, the network entity can be capable of authenticating the client based upon a comparison of the authentication code and the comparison code, such as by identifying a match between the authentication code and the comparison code when the client is an authorized client.

According to other aspects of the present invention, a client, network entity, method and computer program product are provided for providing digital rights management of content such as electronic games. Exemplary embodiments of the present invention therefore provide an improved system, client, network entity, method and computer program product for providing digital rights management of electronic games. As indicated above, and explained more fully below, exemplary embodiments of the present invention provide a framework for providing digital rights management of access-restricted digital content in a dynamic manner that overcomes the drawback of conventional DRM techniques. In this regard, exemplary embodiments of the present invention are capable of dynamically and repeatedly authenticating a client based upon information readily available to the client, where such information may otherwise be difficult to manipulate. In addition, exemplary embodiments of the present invention are capable of authenticating a client based upon content stored in memory of the client in a manner that inhibits use of illegally duplicated content. As such, the system, client, network entity, method and computer program product of exemplary embodiments of the present invention solve the problems identified by prior techniques and provide additional advantages.

### BRIEF DESCRIPTION OF THE DRAWINGS

Having thus described the invention in general terms, reference will now be made to the accompanying drawings, which are not necessarily drawn to scale, and wherein:

FIG. 1 is a block diagram of one type of terminal and system that would benefit from exemplary embodiments of the present invention;

FIG. 2 is a schematic block diagram of an entity capable of operating as a mobile station, game server, proxy server, personal computer (PC) system and/or game console, in accordance with exemplary embodiments of the present invention;

FIG. 3 is a schematic block diagram more particularly illustrating a mobile station in accordance with one exemplary embodiment of the present invention;

FIG. 4 is a schematic block diagram of an exemplar configuration of various network entities of the system of FIG. 1, in accordance with one exemplary embodiment of the present invention;

FIGS. 5 and 6 are functional block diagrams of a client operating a digital rights management (DRM) agent before and/or during interaction with a network entity, in accordance with one exemplary embodiment of the present invention; and

FIG. 7 is a flowchart including various steps in a method of providing digital rights management of content such as an electronic game, in accordance with one exemplary embodiment of the present invention.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the exemplary embodiments set forth herein; rather, these exemplary embodiments are provided so that this disclosure will be thorough and complete, and will fully convey the scope of the invention to those skilled in the art. Like numbers refer to like elements throughout.

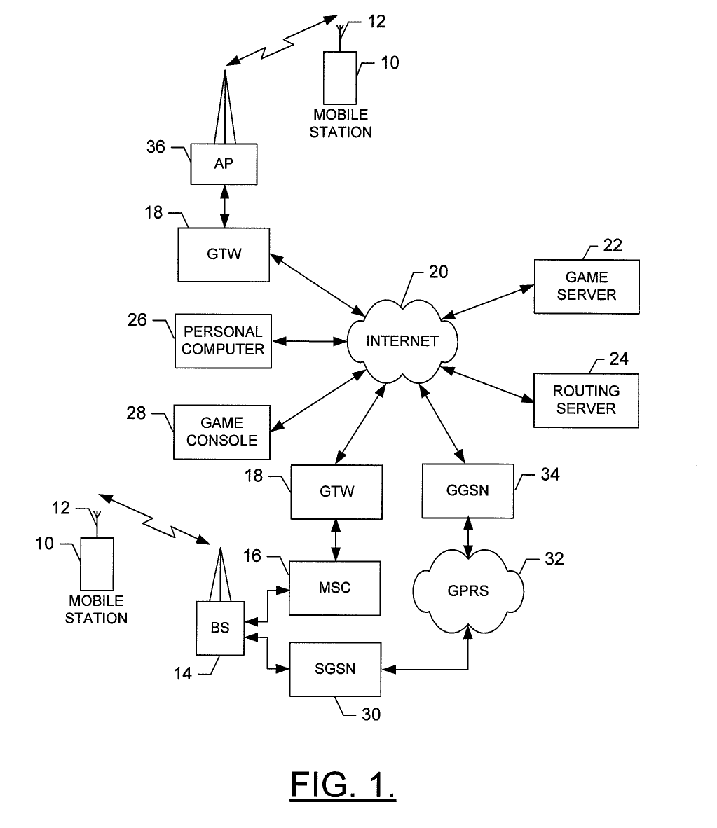

Referring to FIG. 1, an illustration of one type of system that would benefit from the present invention is provided. The system, method and computer program product of exemplary embodiments of the present invention will be primarily described in conjunction with mobile communications applications. It should be understood, however, that the system, method and computer program product of exemplary embodiments of the present invention can be utilized in conjunction with a variety of other applications, both in the mobile communications industries and outside of the mobile communications industries. For example, the system, method and computer program product of exemplary embodiments of the present invention can be utilized in conjunction with wireline and/or wireless network (e.g., Internet) applications.

The system can include one or more mobile stations 10, each having an antenna 12 for transmitting signals to and for receiving signals from one or more base stations (BS's) 14, one of each being shown in FIG. 1. The base station is a part of one or more cellular or mobile networks that each includes elements required to operate the network, such as one or more mobile switching centers (MSC) 16. As well known to those skilled in the art, the mobile network may also be referred to as a Base Station/MSC/Interworking function (BMI). In operation, the MSC is capable of routing calls, data or the like to and from mobile stations when those mobile stations are making and receiving calls, data or the like. The MSC can also provide a connection to landline trunks when mobile stations are involved in a call.

The MSC 16 can be coupled to a data network, such as a local area network (LAN), a metropolitan area network (MAN), and/or a wide area network (WAN). The MSC can be directly coupled to the data network. In one exemplary embodiment, however, the MSC is coupled to a Gateway (GTW) 18, and the GTW is coupled to a WAN, such as the Internet 20. In turn, devices such as processing elements (e.g., personal computers, server computers or the like) can be coupled to the mobile station 10 via the Internet. For example, as explained below, the processing elements can include one or more processing elements associated with one or more game servers 22, routing servers 24, personal computer (PC) systems 26, game consoles 28, or the like, one of each being illustrated in FIG. 1 and described below. As will be appreciated, the processing elements can comprise any of a number of processing devices, systems or the like capable of operating in accordance with exemplary embodiments of the present invention.

The BS 14 can also be coupled to a Serving GPRS (General Packet Radio Service) Support Node (SGSN) 30. As known to those skilled in the art, the SGSN is typically capable of performing functions similar to the MSC 16 for packet switched services. The SGSN, like the MSC, can be coupled to a data network, such as the Internet 20. The SGSN can be directly coupled to the data network. In a more typical exemplary embodiment, however, the SGSN is coupled to a packet-switched core network, such as a GPRS core network 32. The packet-switched core network is then coupled to another GTW, such as a GTW GPRS support node (GGSN) 34, and the GGSN is coupled to the Internet.

Although not every element of every possible network is shown and described herein, it should be appreciated that the mobile station 10 may be coupled to one or more of any of a number of different networks. In this regard, mobile network(s) can be capable of supporting communication in accordance with any one or more of a number of first-generation (1G), second-generation (2G), 2.5G and/or third-generation (3G) mobile communication protocols or the like. More particularly, one or more mobile stations may be coupled to one or more networks capable of supporting communication in accordance with 2G wireless communication protocols IS-136 (TDMA), GSM, and IS-95 (CDMA). Also, for example, one or more of the network(s) can be capable of supporting communication in accordance with 2.5G wireless communication protocols GPRS, Enhanced Data GSM Environment (EDGE), or the like. In addition, for example, one or more of the network(s) can be capable of supporting communication in accordance with 3G wireless communication protocols such as Universal Mobile Telephone System (UMTS) network employing Wideband Code Division Multiple Access (WCDMA) radio access technology. Some narrow-band AMPS (NAMPS), as well as TACS, network(s) may also benefit from exemplary embodiments of the present invention, as should dual or higher mode mobile stations (e.g., digital/analog or TDMA/CDMA/analog phones).

One or more mobile stations 10 (as well as one or more processing elements, although not shown as such in FIG. 1) can further be coupled to one or more wireless access points (APs) 36. The AP's can be configured to communicate with the mobile station in accordance with techniques such as, for example, radio frequency (RF), Bluetooth (BT), infrared (IrDA) or any of a number of different wireless networking techniques, including WLAN techniques. The APs may be coupled to the Internet 20. Like with the MSC 14, the AP's can be directly coupled to the Internet. In one exemplary embodiment, however, the APs are indirectly coupled to the Internet via a GTW 18. As will be appreciated, by directly or indirectly connecting the mobile stations and the user processors (e.g., game servers 22, routing servers 24, personal computer (PC) systems 26, game consoles 28) and/or any of a number of other devices to the Internet, whether via the AP's or the mobile network(s), the mobile stations and user processors can communicate with one another to thereby carry out various functions of the respective entities, such as to transmit and/or receive data, content or the like. As used herein, the terms “data,” “content,” “information,” and similar terms may be used interchangeably to refer to data capable of being transmitted, received and/or stored in accordance with exemplary embodiments of the present invention. Thus, use of any such terms should not be taken to limit the spirit and scope of the present invention.

Although not shown in FIG. 1, in addition to or in lieu of coupling the mobile stations 10 to game servers 22, routing servers 24, personal computer (PC) systems 26 and/or game consoles 28 across the Internet 20, one or more such entities may be directly coupled to one another. As such, one or more network entities may communicate with one another in accordance with, for example, RF, BT, IrDA or any of a number of different wireline or wireless communication techniques, including LAN and/or WLAN techniques.

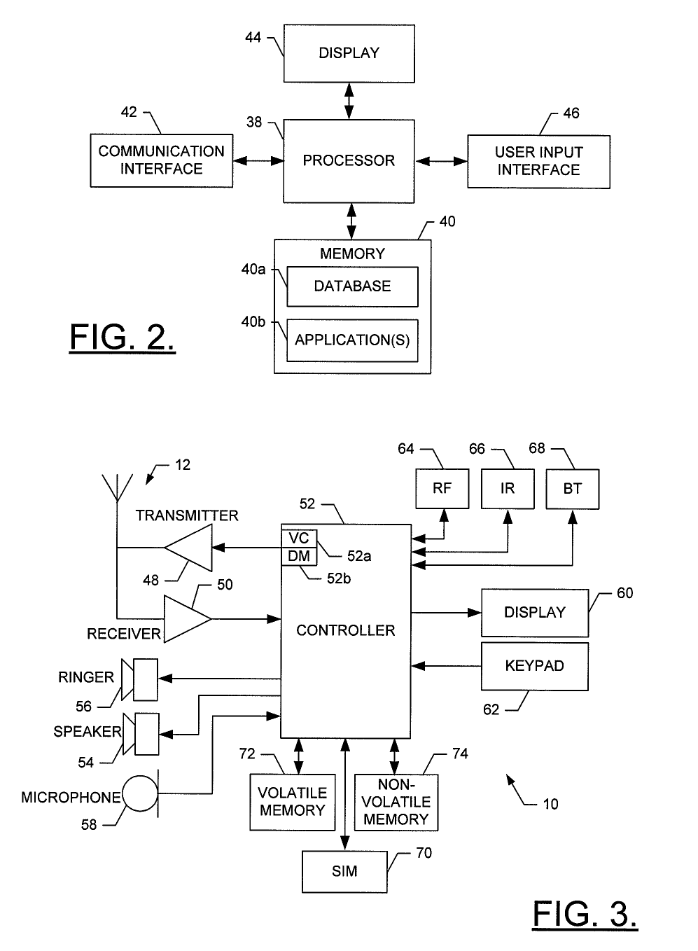

Referring now to FIG. 2, a block diagram of an entity capable of operating as a mobile station 10, game server 22, routing server 24, personal computer (PC) system 26 and/or game console 28, is shown in accordance with one exemplary embodiment of the present invention. Although shown as separate entities, in some exemplary embodiments, one or more entities may support one or more of a mobile station, game server, routing server, personal computer (PC) system and/or game console, logically separated but co-located within the entit(ies). For example, a single entity may support a logically separate, but co-located, game server and routing server. Also, for example, a single entity may support a logically separate, but co-located personal computer and game console.

The entity capable of operating as a mobile station 10, game server 22, routing server 24, personal computer (PC) system 26 and/or game console 28 includes various means for performing one or more functions in accordance with exemplary embodiments of the present invention, including those more particularly shown and described herein. It should be understood, however, that one or more of the entities may include alternative means for performing one or more like functions, without departing from the spirit and scope of the present invention. More particularly, for example, as shown in FIG. 2, the entity can include a processor 38 connected to a memory 40. The memory can comprise fixed and/or removable, volatile and/or non-volatile, memory that typically stores content, data or the like. For example, the memory typically stores content transmitted from, and/or received by, the entity. Also for example, when the entity comprises a game server or routing server, the memory can store a database 40a of clients capable of interacting with the respective entity, such as those clients registered to play an online game, where one or more clients in the database may be associated with a mapping of at least a portion of content stored by the respective clients and the location(s) in the respective client memory where the content is stored.

In addition, for example, the memory 40 of the entity capable of operating as a mobile station 10, game server 22, routing server 24, personal computer (PC) system 26 and/or game console 28 typically stores client applications 40b, instructions or the like for the processor to perform steps associated with operation of the entity in accordance with exemplary embodiments of the present invention. For example, when the entity comprises a game server or routing server, the memory can store a digital rights management (DRM) manager capable of managing the rights of clients (e.g., mobile station 10, personal computer (PC) system 26, game console 28, etc.) to play one or more electronic games, such as those clients included in the database 40a. As also explained below, for example, when the entity comprises a mobile station, personal computer (PC) system or game console, the memory can store a DRM agent capable of communicating with the DRM manager to thereby authorize the respective entity to play one or more electronic games.

As described herein, applications such as the DRM manager and/or DRM agent may comprise software operated by the respective entities. It should be understood, however, that any one or more of the applications described herein can alternatively comprise firmware or hardware, without departing from the spirit and scope of the present invention. Generally, then, network entities such as the mobile station 10, game server 22, routing server 24, personal computer (PC) system 26 and/or game console 28 can include one or more logic elements for performing various functions of one or more client application(s). As will be appreciated, the logic elements can be embodied in any of a number of different manners. In this regard, the logic elements performing the functions of one or more client applications can be embodied in an integrated circuit assembly including one or more integrated circuits integral or otherwise in communication with a respective network entity (i.e., mobile station, game server, routing server, personal computer (PC) system, game console, etc.) or more particularly, for example, a processor 38 of the respective network entity. The design of integrated circuits is by and large a highly automated process. In this regard, complex and powerful software tools are available for converting a logic level design into a semiconductor circuit design ready to be etched and formed on a semiconductor substrate. These software tools, such as those provided by Avant! Corporation of Fremont, Calif. and Cadence Design, of San Jose, Calif., automatically route conductors and locate components on a semiconductor chip using well established rules of design as well as huge libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

In addition to the memory 40, the processor 38 can also be connected to at least one interface or other means for displaying, transmitting and/or receiving data, content or the like. In this regard, the interface(s) can include at least one communication interface 42 or other means for transmitting and/or receiving data, content or the like, as well as at least one user interface that can include a display 44 and/or a user input interface 46. The user input interface, in turn, can comprise any of a number of devices allowing the entity to receive data from a user, such as a keypad, a touch display, a joystick or other input device.

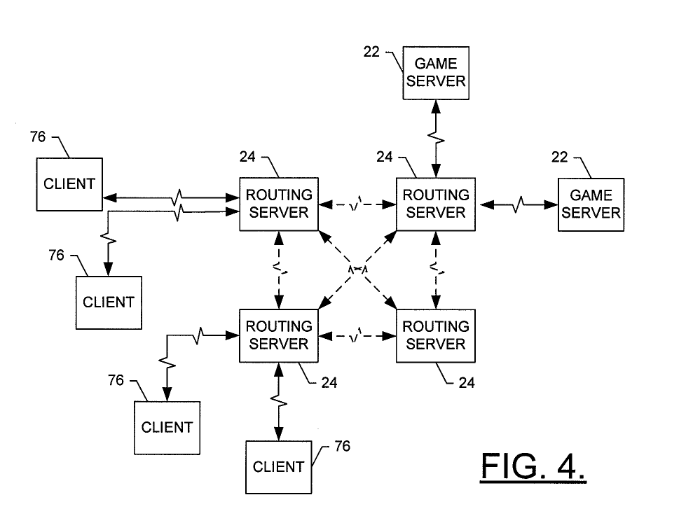

Reference is now made to FIG. 3, which illustrate one type of mobile station 10, a mobile telephone, which would benefit from exemplary embodiments of the present invention. It should be understood, however, that the mobile station illustrated and hereinafter described is merely illustrative of one type of mobile station that would benefit from the present invention and, therefore, should not be taken to limit the scope of the present invention. While several exemplary embodiments of the mobile station are illustrated and will be hereinafter described for purposes of example, other types of mobile stations, such as portable digital assistants (PDAs), pagers, laptop computers, mobile gaming devices and other types of electronic systems, can readily employ the present invention.

The MN 10 includes various means for performing one or more functions in accordance with exemplary embodiments of the present invention, including those more particularly shown and described herein. It should be understood, however, that the MN may include alternative means for performing one or more like functions, without departing from the spirit and scope of the present invention. More particularly, for example, as shown in FIG. 3, in addition to an antenna 14, the mobile station can include a transmitter 48, receiver 50, and controller 52 or other processor that provides signals to and receives signals from the transmitter and receiver, respectively. These signals include signaling information in accordance with the air interface standard of the applicable cellular system, and also user speech and/or user generated data. In this regard, the mobile station can be capable of operating with one or more air interface standards, communication protocols, modulation types, and access types. More particularly, the mobile station can be capable of operating in accordance with any of a number of first generation (1G), second generation (2G), 2.5G and/or third-generation (3G) communication protocols or the like. For example, the mobile station may be capable of operating in accordance with 2G wireless communication protocols IS-136 (TDMA), GSM, and IS-95 (CDMA). Also, for example, the mobile station may be capable of operating in accordance with 2.5G wireless communication protocols GPRS, EDGE, or the like. Further, for example, the mobile station may be capable of operating in accordance with 3G wireless communication protocols such as UMTS network employing WCDMA radio access technology. Some NAMPS, as well as TACS, mobile stations may also benefit from the teaching of this invention, as should dual or higher mode phones (e.g., digital/analog or TDMA/CDMA/analog phones).

It is understood that the controller 52 includes the circuitry required for implementing the audio and logic functions of the mobile station 10. For example, the controller may be comprised of a digital signal processor device, a microprocessor device, and various analog-to-digital converters, digital-to-analog converters, and other support circuits. The control and signal processing functions of the mobile station are allocated between these devices according to their respective capabilities. The controller can additionally include an internal voice coder (VC) 52a, and may include an internal data modem (DM) 52b. Further, the controller may include the functionally to operate one or more client software programs such as those indicated above, which may be stored in memory (described below).

The mobile station 10 also comprises a user interface including a conventional earphone or speaker 54, a ringer 56, a microphone 58, a display 60, and a user input interface, all of which are coupled to the controller 52. Although not shown, the mobile station can include a battery for powering the various circuits that are required to operate the mobile station, as well as optionally providing mechanical vibration as a detectable output. The user input interface, which allows the mobile station to receive data, can comprise any of a number of devices allowing the mobile station to receive data, such as a keypad 52, a touch display (not shown), a joystick (not shown) or other input device. In exemplary embodiments including a keypad, the keypad includes the conventional numeric (0-9) and related keys (#, *), and other keys used for operating the mobile station.

The mobile station 10 can also include one or more means for sharing and/or obtaining data. For example, the mobile station can include a short-range radio frequency (RF) transceiver or interrogator 64 so that data can be shared with and/or obtained from electronic devices in accordance with RF techniques. The mobile station can additionally, or alternatively, include other short-range transceivers, such as, for example an infrared (IR) transceiver 66, and/or a Bluetooth (BT) transceiver 68 operating using Bluetooth brand wireless technology developed by the Bluetooth Special Interest Group. The mobile station can therefore additionally or alternatively be capable of transmitting data to and/or receiving data from electronic devices in accordance with such techniques. Although not shown, the mobile station can additionally or alternatively be capable of transmitting and/or receiving data from electronic devices according to a number of different wireless networking techniques, including WLAN techniques such as IEEE 802.11 techniques or the like.

The mobile station 10 can further include memory, such as a subscriber identity module (SIM) 70, a removable user identity module (R-UIM) or the like, which typically stores information elements related to a mobile subscriber. In addition to the SIM, the mobile station can include other removable and/or fixed memory. In this regard, the mobile station can include volatile memory 72, such as volatile Random Access Memory (RAM) including a cache area for the temporary storage of data. The mobile station can also include other non-volatile memory 74, which can be embedded and/or may be removable. The non-volatile memory can additionally or alternatively comprise an EEPROM, flash memory or the like. The memories can store any of a number of software applications, instructions, pieces of information, and data, used by the mobile station to implement the functions of the mobile station.

As will be appreciated, a number of the entities of the system of FIG. 1 can be configured in any of a number of different architectures to perform any of a number of functions, such as to manage a multiplayer game. For example, the entities of the system of FIG. 1 can be configured to manage a multiplayer game in a centralized client-server architecture, decentralized architecture and/or proxy architecture. Additionally or alternatively, for example, the entities of the system of FIG. 1 can be configured in an architecture given in the Scalable Network Application Package (SNAP) (formerly Sega Network Application Package) provided by Nokia Corporation for applications such as in the context of multiplayer gaming.

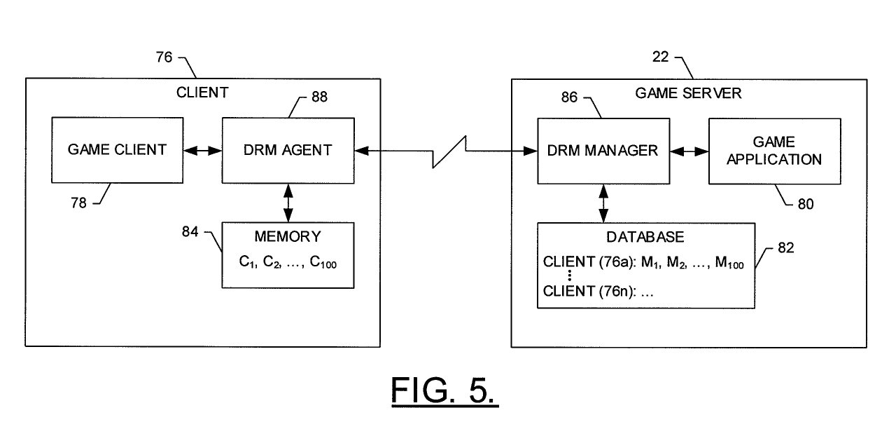

More particularly, as shown in FIG. 4, for example, one or more mobile stations 10, PC systems 26 and/or game consoles 28 may operate as clients 76 in a gaming architecture that also includes one or more game servers 22 and/or routing servers 24. In the illustrated architecture, similar to a conventional client-server architecture, the game servers operate games and maintain the state of those games. As will be appreciated, however, the routing servers and/or one or more of the clients themselves may alternatively operate portions, or all, of the games and maintain the state of those games. As used herein, then, although games can be operated by one or more network entities, including game servers, routing servers and/or client(s), the following description may refer to a game server as operating the games for purposes of illustration. Irrespective of the network entit(ies) that operate the games, however, the clients operate game applications that communicate with those network entit(ies) to continuously change the game state of the games operated and maintained by the network entit(ies) to thereby play those games.

Also in the illustrated architecture, the clients 76 are operatively coupled to routing servers 24 which, in turn, are coupled to the game servers 22. Thus, the routing servers route data packets between one or more clients 76 and the game servers 22, and/or other clients, to facilitate the operation of each entity in the architecture. As shown, the routing servers can be coupled between groups of clients and one or more game servers, directly or indirectly via one or more other routing servers. In this regard, one or more routing servers can also be coupled to other routing servers such that the routing servers can also be coupled between one or more clients and one or more groups of other clients, such as groups of clients coupled to other routing servers.

As explained above in the background section, although legal and regulatory means currently exist to protect digital content such as electronic games, digital rights management (DRM) technologies are currently being adopted as a trusted end-to-end solution for the management of digital rights. And although current DRM techniques are adequate in protecting copyrighted or otherwise access-controlled content, a number of such techniques can be circumvented, robbing such techniques from their intended purpose of controlling access to digital content such as electronic games.

Exemplary embodiments of the present invention therefore provide a framework for providing digital rights management of access-restricted digital content in a manner overcoming the drawback of conventional DRM techniques. Exemplary embodiments of the present invention are applicable in a number of different contexts for a number of different types of digital content. In one typical context, for example, a client 76 desiring access to an electronic game, and a network entity controlling access to the electronic game, both operate in an otherwise insecure environment where the same or a different network entity is capable of operating and maintaining the state of the electronic games.

More particularly, the network entity controlling access to the electronic game can, at one or more instances, challenge the client to authenticate itself as being authorized to play the electronic game. In this regard, for each challenge, the network entity controlling access to the electronic game can identify one or more portions of memory of the client, including portions storing the respective electronic game and/or other portions of memory of the client (e.g., read-only memory (ROM), etc.). The client can then generate an authentication code, such as a digital signature, based upon the content stored in the identified portions of memory, and return the generated authentication code to the network entity. In turn, the network entity can attempt to authenticate the client based upon the authentication code, such as by matching the authentication code with a comparison code similarly generated based upon content stored in the same identified portions of memory of a known-authorized client. If authenticated, the network entity permits the client to play, or continue to play, the electronic game. Otherwise, the network entity prevents the client from playing the electronic game.

For one or more challenges of the client 76, the network entity can identify one or more different portions of memory of the client. Exemplary embodiments of the present invention therefore provide a framework for providing digital rights management of digital content such as electronic games in a dynamic manner based upon information readily available to the client, where such information may otherwise be difficult to manipulate. Also, by challenging the client at a number of different instances by identifying repeatedly differing portion(s) of memory, exemplary embodiments of the present invention can inhibit use of illegally duplicated electronic games since to do so would require the unauthorized client to pre-store the entire memory of the authorized client.

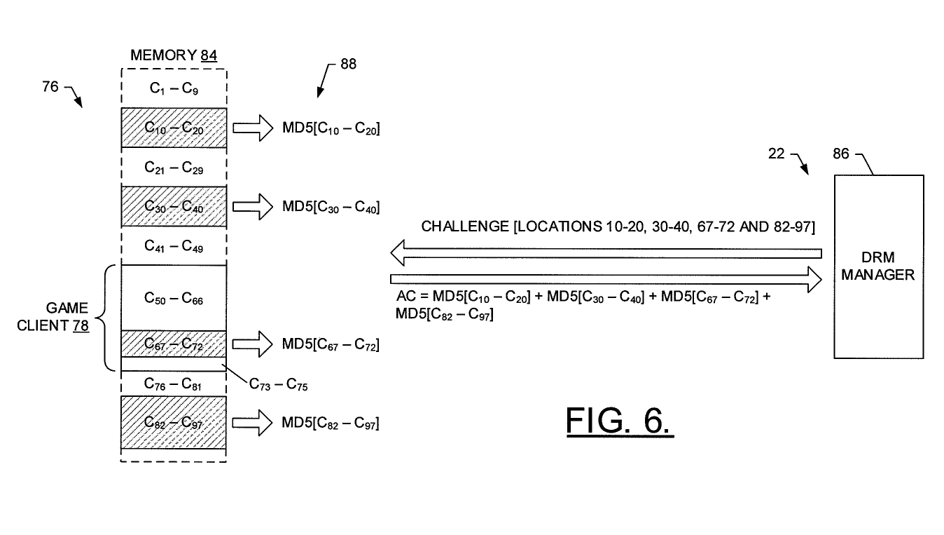

Reference is now drawn to FIGS. 5, 6 and 7, which illustrate functional block diagrams and method, respectively, for providing digital rights management of digital content such as an electronic game. As shown in FIGS. 5 and 6, a client 76 communicates with a game server 22 to play an electronic game. In this regard, the client is capable of operating a game client 78 to effectuate game play locally at the client, while the game server is capable of operating a game application 80 for operating the electronic game. In addition, the game server can maintain the state of the game based at least in part on communication with the client, and if so desired, further based at least in part on communication with a number of other clients.

In accordance with exemplary embodiments of the present invention, the game server 22 is capable of maintaining a database 82 (i.e., database 40a) of clients authorized to operate game clients 78, such as to interact with the game server. For example, the game server can maintain a database of those clients 76 who are registered with the game server, such as to interact with the game application 80 to play the electronic game, as indicated above with reference to FIG. 2. The database can further include, associated with a number of clients, a mapping of at least a portion of the content stored in memory 84 (i.e., memory 40) of the respective clients (or a representation of at least a portion of such content) and the location(s) in the respective client memory where the mapped content is stored. As explained below, M_{L} represents the mapping of content C_{L} stored at location L in memory of a client such that, for an authorized client, M_{L}=C_{L}.

For each of a number of clients 76, for example, the database 82 can include a mapping of content stored in random portions of memory 84 of the client, where the mapped content is associated with the location(s) in the memory of the client where the content is stored. In this regard, the portions of client memory can include, for example, a mapping of portions of the client's non-volatile memory storing the game client, as well as portions of the client's ROM. The memory location(s) of the mapped content can be the same from client to client, or differ between one or more clients. Thus, whereas the database may include a mapping of content M₁-M₁₀₀ of one client, the database may include M₁-M₂₀ and M₁₂₁-M₂₀₀ of another client.

In addition to the database 82, the game server 22 can operate a DRM manager 86 capable of capable of managing the rights of clients 76, such as those clients included in the database, to interact with the game server and/or access respective game clients 78, such as to permit or prevent the client users to play one or more electronic games. In this regard, as explained below, the DRM manager can be capable of managing the rights of a client by selecting at least a portion of the content in memory 84 of the client, that portion of the content also being mapped into the database of the game server. The DRM manager can then provide or otherwise transfer, to the client, an authentication challenge to the client identifying the selected portion of content, such as by the location(s) in memory of the client where the selected portion of content is stored.

The client 76, or more particularly a DRM agent 88 operated by the client, can receive the authentication challenge, and generate an authentication code based upon the identified portion of content stored in memory of the client, such as that portion of content in the memory location(s) identified in the authentication challenge. The DRM agent can return the authentication code to the DRM manager 84 in response to the authentication challenge from the DRM manager. The DRM manager can then attempt to authenticate the client 76 based upon the code, such as by matching the code with a comparison code similarly generated by a known-authorized client. If authenticated, the DRM manager permits the client to play, or continue to play, the electronic game. Otherwise, the DRM manager prevents the client from playing the electronic game.

As shown and described herein, the game application 80 and the DRM manager 86 comprise separate applications operated by the game server 22, or more generally the network entity operating and maintaining the state of an electronic game. It should be understood, however, that one or more applications may support both of the game application and the DRM manager, logically separated but co-located within the application(s). For example, an application may support both the game application and DRM manager. At the client 76, one or applications may similarly support both of the game client 78 and the DRM agent 88, logically separated but co-located within the same application. Further, as shown and described herein, the DRM manager 86 is operated by the network entity operating and maintaining the state of an electronic game, such as the game server 22. It should be understood, however, that the DRM manager can alternatively be operated by any of a number of other network entities (e.g., routing servers 24) in communication with the network entity operating and maintaining the state of an electronic game to thereby provide digital rights management to the electronic game.

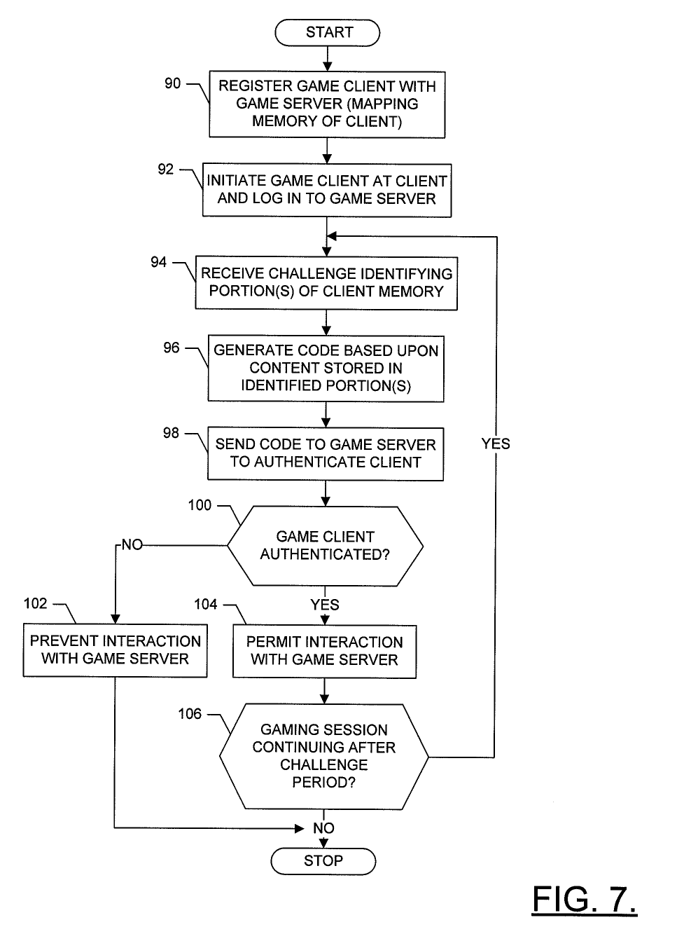

Now with reference to FIG. 7, a method of managing for providing digital rights management of an electronic game includes providing at least one client 76 authorized to interact with a game server 22, or more particularly a game application 80 operated by a game server, to thereby play an electronic game. For example, a plurality of clients, or client users, may register with the game server to play an electronic game operated and maintained by the game server, such as by means of game clients 78 operated by the respective clients, as shown in block 90. As the clients register with the game server, the DRM manager 86 may facilitate registering the client users with the game server, and thereafter maintain a database 82 of those registered clients or client users. In this regard, the DRM manager can maintain a database of registered client users, where the database includes a number of different pieces of information associated with the clients or client users. For example, the DRM manager can request, and thereafter receive for the client users, a username and/or password with which the client user can log in to interact with the game server to play an electronic game. Also, for example, the DRM manager can request, and thereafter receive, a serial number of other identifier uniquely identifying the particular copy of the game client stored by the client.

In addition, for example, as the client registers with the game server, the DRM manager 86 can map at least a portion, if not all, of the content stored in memory 84 (i.e., memory 40) of the client. For example, the DRM manager can map portions of the content stored in memory of the client including portions of the client's ROM and/or portions of the game client 78 stored in client memory. In this regard, the DRM manager can map portions of the content stored by the client, such as portions of the game client, more likely to be modified by an unauthorized client in an attempt to gain unauthorized access to the game client, and thus the game application 80. Irrespective of the exact portions of content mapped by the DRM manager, the DRM manager can store, associated with the client or client user in the database 82, the mapped portion(s) of the content and the location(s) in the respective client memory where the content is stored (e.g., M₁-M₁₀₀). In lieu of storing the actual mapped portions of content, the DRM manager can alternatively store a representation of the mapped portions of content. For example, the DRM manager can hash the mapped content, such as in accordance with the MD5 technique, and thereafter store the hashed content and location(s) in association with the client (e.g., MD5[M₁]-MD5[M₁₀₀]). For purposes of example, the DRM manager may be described as storing the mapped content, although it should be understood that the DRM manager can equally store a hash or other representation of the mapped content, without departing from the spirit and scope of the present invention.

After registering with the game server 22, to play the electronic game operated and maintained by the game server, the registered client users may initiate the game client 78 to log in or otherwise authenticate to the game server, as shown in block 92. After being initiated, the game client can in turn initiate the DRM agent 88 to authenticate the client user and the client 76 to the game server. To authenticate the client user to the game server, the DRM agent 88 can request a username and password from the client user. After receiving the username/password, the DRM agent can send or otherwise transfer the username/password to the game server, or more particularly the DRM manager 86. The DRM manager can then attempt to authenticate the client user by searching the database 82 for a username/password matching that of a registered client user. If the DRM manager fails to authenticate the client user, the DRM manager can prevent the client 76, or more particularly the game client, from interacting with the game server. For example, the DRM manager can prevent the game client from interacting with the game application 80 operated by the game server. Additionally or alternatively, for example, the DRM manager can notify the DRM agent of the authentication failure such that the DRM agent can prevent the client from operating the game client, such as to interact with the game application. Further, for example, the DRM manager can maintain an identity of the client, such as an IMEI code for a mobile station 10, in the database such that, for future authentication challenges to that client, the DRM manager can quickly identify the client as being unauthorized to play the electronic game.

If the DRM manager 86 successfully authenticates the client user, the DRM manager can continue by authenticating the client 76 to the game server 22. By separately authenticating the client user and the client, the DRM manager can reduce the likelihood that an unauthorized client user is capable of using the username/password of an authorized user to authenticate to the game server to enable interaction with the game server. To authenticate the client, the DRM manager can locate the entry in the database 82 for the client or client user, and select one or more memory locations L of the respective client for which the database includes mapped content M_{L} (or a representation of such content), such as in a random manner. For example, presume that the database includes a mapping of content M₁-M₁₀₀ of a client. In such an instance, the DRM manager can select content from one or more of memory locations 1-100, such as M₁₀-M₂₀, M₃₀-M₄₀, M₆₇-M₇₂ and M₈₂-M₉₇ (Mₓₓ-M_{yy} representing mapped content across a range of memory locations xx to yy). Thereafter, the DRM manager can send or otherwise transfer an authentication challenge to the client, where the authentication challenge identifies the selected location(s) in memory of the client (e.g., 10-20, 30-40, 67-72 and 82-97), as shown in FIG. 6 and block 94 of FIG. 7.

After receiving the authentication challenge, the DRM agent 88 operated by the client 76 can generate an authentication code (AC) based upon the content stored in memory 84 of the client at the selected location(s) identified in the authentication challenge, as shown in block 96. The DRM agent can generate the authentication code in a number of different manners understood to both the DRM agent and the DRM manager 86, such as by hashing the content stored in memory at the selected location(s). For example, for a challenge identifying memory locations 10-20, 30-40, 67-72 and 82-97, the DRM agent can generate an authentication code by hashing C₁₀-C₂₀, C₃₀-C₄₀, C₆₇-C₇₂ and C₈₂-C₉₇ stored in memory of the client (Cₓₓ-C_{yy} representing stored content across a range of memory locations xx to yy), such as in accordance with the MD5 technique. For more information on such a technique, see Internet Engineering Task Force (IETF) request for comments document RFC 1321, entitled: The MD5 Message-Digest Algorithm, April 1992, the contents of which are hereby incorporated by reference in its entirety. In such instances, the authentication code can comprise a hash of all of the content stored at the identified memory location(s) (i.e., AC=MD5[(C₁₀-C₂₀)+(C₃₀-C₄₀)+(C₆₇-C₇₂)+(C₈₂-C₉₇)]), or as shown in FIG. 6, can alternatively comprise a concatenated sequence of a hash of the content stored in each memory location (i.e., AC=MD5[C₁₀-C₂₀]+MD5[C₃₀-C₄₀]+MD5[C₆₇-C₇₂]+MD5[C₈₂-C₉₇]).

Irrespective of how the DRM agent 88 generates the authentication code AC, the DRM agent can return the authentication code to the DRM manager 86 to thereby permit the DRM manager to authenticate the client based upon the authentication code, as shown in block 98. In this regard, the DRM manager can authenticate the client by attempting to match, the mapped content M stored in the database 82 associated with the client, with the content C stored in memory 84 of the client, at the memory location(s) L identified in the authentication challenge. That is, for each memory location identified in the authentication challenge, the DRM manager can determine if M_{L}=C_{L}, as such is the case for an authorized client.

More particularly, the DRM manager 86 can retrieve, from the database 82 of the game server 22, the mapped content of the client for the selected memory location(s) identified in the authentication challenge. In this regard, the mapped content may be identified in the database as being that associated with the username/password of the respective client user previously received to authenticate the client user. Alternatively, the mapped content may be identified in the database as being that associated with the serial number of the particular copy of the game client 78 initiate by the client, the serial number being communicated to the DRM manager after initiation of the game client.

Continuing the above example, then, the DRM manager 86 can retrieve mapped content M₁₀-M₂₀, M₃₀-M₄₀, M₆₇-M₇₂ and M₈₂-M₉₇ for a challenge identifying memory locations 10-20, 30-40, 67-72 and 82-97. The DRM manager can then generate a comparison code (CC) based upon the respective mapped content in a manner similar to the manner the DRM agent generated the authentication code. For example, the DRM manager can generate a comparison code by hashing the mapped content for each identified memory location (e.g., CC=MD5[M₁₀-M₂₀]+MD5[M₃₀-M₄₀]+MD5[M₆₇-M₇₂]+MD5[M₈₂-M₉₇]; or CC=MD5[(M₁₀-M₂₀)+(M₃₀-M₄₀)+(M₆₇-M₇₂)+(M₈₂-M₉₇)]). Alternatively, in instances where the database 82 stores a representation of the mapped portions of content, the DRM manager can generate the comparison code by processing the representation into the appropriate comparison code, such as by concatenating the mapped, hashed content into the appropriate comparison code.

After generating the comparison code, the DRM manager 86 can compare the authentication code and the comparison code to determine if the mapped content stored in the database 82 for the client 76 matches the content stored in memory 84 of the client, for the identified memory location(s), as shown in block 100. If the DRM manager fails to identify a match to thereby authenticate the client, the DRM manager can prevent the client, or more particularly the game client 78, from interacting with the game server 22, as shown in block 102. Similar to before, for example, the DRM manager can prevent the game client from interacting with the game application 80 operated by the game server. Additionally or alternatively, for example, the DRM manager can notify the DRM agent of the authentication failure such that the DRM agent can prevent the client from operating the game client, such as to interact with the game application. Further, for example, the DRM manager can maintain an identity of the client, such as an IMEI code for a mobile station 10, in the database such that, for future authentication challenges to that client, the DRM manager can quickly identify the client as being unauthorized to play the electronic game.

If the DRM manager 86 successfully identifies a match to thereby authenticate the client 76, the DRM manager can permit the client to interact with the game server 22, as shown in block 104. More particularly, the DRM manager can permit the game client 78 to interact with the game application 80 operated by the game server to thereby play the electronic game. In such instances, the client user and the client have both been authenticated to the game server to interact with the game application to play the electronic game.

During a gaming session in which the client 76 interacts with the electronic game operated by the game application 80 to effectuate game play, the DRM manager 86 and DRM agent 88 can function to perform one or more authentication challenge operations at one or more irregular or regular time intervals to authenticate and re-authenticate the client. For example, the DRM manager can be configured to authenticate the client at the end of one or more challenge periods, each of which defines a period of time for which a previous client authentication is considered valid, as shown in block 106. During each authentication challenge operation, then, the DRM manager can, as before, select one or more memory locations L of the respective client for which the database includes mapped content M_{L} (or a representation of such content), such as in a random manner. The memory locations selected from one challenge operation to the next can differ. And as such, the client must typically dynamically generate authentication codes, thereby inhibiting use of illegal access to the electronic game since to do so would requite the unauthorized client to pre-store the entire memory of the authorized client (or at least that portion of memory mapped in the database 82). Then, after selecting memory locations of the client, the DRM manager can request an authentication code from the client based upon the identified memory locations, and thereafter attempt to authenticate the client based upon the authentication code and the mapped content of the client in the database for the identified locations. Thus, if the DRM manager successfully authenticates the client, the client can continue to interact with the game server 22 (see block 104). Otherwise, the client is prevented from continued interaction with the game server (see block 102), such as by severing the interaction or connection between the client and the game server instantly, at a randomly-delayed time, or the like.

As described above, the DRM manager 86 can be configured to authenticate the client user before authenticating the client 76. It should be understood, however, that the DRM manager need not authenticate the client user. In such instances, the DRM manager can begin the authentication challenge upon initiation of the game client 78 at the client, without first authenticating the client user by means of a usemame/password associated with the client user. Further, it should be understood that the DRM manager need not authenticate the client before permitting initial interaction with the game server 22. For example, the DRM manager can be configured to authenticate the client user, and if the client user is authenticated, permit interaction with the game server. Then, after a period of time (e.g., challenge period), the DRM manager can begin the first authentication challenge to authenticate the client.

Exemplary embodiments of the present invention have been shown and described with respect to play of an electronic game. It should be understood, however, that exemplary embodiments of the present invention are equally applicable outside the context of electronic gaming. In general, then, the DRM manager can be adapted to authenticate a client in a number of other contexts whereby the client is capable of communicating with the DRM manager to be authenticated. For example, in the context of streaming multimedia content from a network entity to a client, the DRM manager may be adapted to authenticate the client to access, or continue to access, the streaming content. In such instances, the DRM may be adapted to communicate with a DRM agent integral, or in communication, with a multimedia player capable of receiving and presenting the streaming content.

According to one exemplary aspect of the present invention, the functions performed by one or more of the entities of the system, such as the game server 22, routing server 24 and/or client 76 (e.g., mobile station 10, PC system 26, game console 28, etc.), may be performed by various means, such as hardware and/or firmware, including those described above, alone and/or under control of a computer program product (e.g., game client 78, game application 80, DRM manager 86, DRM agent 88, etc.). The computer program product for performing one or more functions of exemplary embodiments of the present invention includes a computer-readable storage medium, such as the non-volatile storage medium, and software including computer-readable program code portions, such as a series of computer instructions, embodied in the computer-readable storage medium.

In this regard, FIG. 7 is a flowchart of methods, systems and program products according to exemplary embodiments of the present invention. It will be understood that each block or step of the flowchart, and combinations of blocks in the flowchart, can be implemented by various means, such as hardware, firmware and/or software including one or more computer program instructions. As will be appreciated, any such computer program instructions may be loaded onto a computer or other programmable apparatus (i.e., hardware) to produce a machine, such that the instructions which execute on the computer or other programmable apparatus create means for implementing the functions specified in the flowchart block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowchart block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowchart block(s) or step(s).

Accordingly, blocks or steps of the flowchart support combinations of means for performing the specified functions, combinations of steps for performing the specified functions and program instruction means for performing the specified functions. It will also be understood that one or more blocks or steps of the flowchart, and combinations of blocks or steps in the flowchart, can be implemented by special purpose hardware-based computer systems which perform the specified functions or steps, or combinations of special purpose hardware and computer instructions.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for providing digital rights management (DRM) of content, the system comprising:
a network entity capable of sending an authentication challenge randomly identifying at least a portion of content stored in memory of a client; and
a client capable of receiving the authentication challenge, generating an authentication code based upon the content identified by the authentication challenge, and sending the authentication code to the network entity in response to the authentication challenge,
wherein the network entity is also capable of receiving the authentication code, and authenticating the client based upon the authentication code.

2. A system according to claim 1 for use in providing digital rights management of an access-controlled application, wherein the network entity is capable of sending, and the client is capable of receiving, an authentication challenge randomly identifying at least a portion of a read-only memory (ROM) of the client and at least a portion of the access-controlled application stored in memory of the client.

3. A system according to claim 1, wherein the network entity is capable of sending an authentication challenge, receiving an authentication code and authenticating the client at a plurality of instances, and wherein the content identified by the authentication challenge in at least one instance differs from the content identified by the authentication challenge in at least one other instance.

4. A client for use in providing digital rights management (DRM) of content, the client comprising:
a memory capable of storing content; and
a processor capable of operating a DRM agent, wherein the DRM agent is capable of receiving an authentication challenge randomly identifying at least a portion of content stored in the memory, and
wherein the DRM agent is capable of generating an authentication code based upon the content identified by the authentication challenge such that the client can thereafter be authenticated based upon the authentication code.

5. A client according to claim 4, wherein the DRM agent is capable of receiving an authentication challenge randomly identifying at least one location in the memory, and
wherein the DRM agent is capable of generating an authentication code based upon the content stored at the identified locations in the memory.

6. A client according to claim 4, wherein the DRM agent is capable of receiving an authentication challenge and generating an authentication code at a plurality of instances, and wherein the content identified by the authentication challenge in at least one instance differs from the content identified by the authentication challenge in at least one other instance.

7. A client according to claim 4 for use in providing digital rights management of an access-controlled application, wherein the memory includes a read-only memory (ROM) and is capable of storing the access-controlled application, wherein the DRM agent is capable of receiving an authentication challenge randomly identifying at least a portion of the ROM and at least a portion of the access-controlled application stored in memory of the client.

8. A client according to claim 4 for providing digital rights management of an access-controlled application adapted to interact with a network entity, wherein the processor is also capable of operating the access-controlled application to interact with the network entity when the client is authenticated.

9. A network entity for providing digital rights management (DRM) of content, the network entity comprising:
a processor capable of operating a DRM manager, wherein the DRM manager is capable of sending an authentication challenge randomly identifying at least a portion of content stored in memory of a client, wherein the DRM manager is capable of receiving an authentication code generated based upon the content identified by the authentication challenge, and thereafter authenticating the client based upon the authentication code.

10. A network entity according to claim 9, wherein the DRM manager is capable of sending an authentication challenge randomly identifying at least one location in memory of a client, and
wherein the DRM manager is capable of receiving an authentication code generated based upon the content stored at the identified locations in memory of the client.

11. A network entity according to claim 10, wherein the DRM manager is further capable of mapping at least a portion of the content stored in memory of a known-authorized client, the mapped content being associated with at least one location in memory of the known-authorized client where the content is stored,
wherein the DRM manager is capable of generating a comparison code based upon the mapped content stored at the identified locations in memory of the known-authorized client, and
wherein the DRM manager is capable of authenticating the client based upon a comparison of the authentication code and the comparison code.

12. A network entity according to claim 11, wherein the DRM manager is capable of receiving an authentication code generated by hashing the content stored at the identified locations in memory of the client,
wherein the DRM manager is capable of generating a comparison code by hashing the mapped content stored at the identified locations in memory of the known-authorized client.

13. A network entity according to claim 9, wherein the DRM manager is capable of sending an authentication challenge, receiving an authentication code and authenticating the client at a plurality of instances, and wherein the content identified by the authentication challenge in at least one instance differs from the content identified by the authentication challenge in at least one other instance.

14. A network entity according to claim 9 for providing digital rights management of an access-controlled application stored in memory of the client, wherein the DRM manager is capable of sending an authentication challenge randomly identifying at least a portion of a read-only memory (ROM) of the client and at least a portion of the access-controlled application stored in memory of the client.

15. A network entity according to claim 9 for providing digital rights management of an access-controlled application adapted to interact with one of the same or a different network entity, wherein the DRM manager is capable of authenticating the client such that the client is thereafter permitted to operate the access-controlled application to interact with the network entity when the client is authenticated, and otherwise prevented from operating the access-controlled application to interact with one of the same or the different network entity.

16. A method of providing digital rights management of content, the method comprising:
receiving an authentication challenge randomly identifying at least a portion of content stored in memory of a client; and
generating an authentication code based upon the content identified by the authentication challenge such that the client can thereafter be authenticated based upon the authentication code.

17. A method according to claim 16, wherein receiving an authentication challenge comprises receiving an authentication challenge randomly identifying at least one location in memory of a client, and
wherein generating an authentication code comprises generating an authentication code based upon the content stored at the identified locations in memory of the client.

18. A method according to claim 16, wherein receiving an authentication challenge and generating an authentication code occur at a plurality of instances, and wherein the content identified by the authentication challenge in at least one instance differs from the content identified by the authentication challenge in at least one other instance.

19. A method according to claim 16 for providing digital rights management of an access-controlled application stored in memory of the client, wherein receiving an authentication challenge comprises receiving an authentication challenge randomly identifying at least a portion of a read-only memory (ROM) of the client and at least a portion of the access-controlled application stored in memory of the client.

20. A method according to claim 16 for providing digital rights management of an access-controlled application adapted to interact with a network entity, wherein the method further comprises:
operating the access-controlled application to interact with the network entity when the client is authenticated.

21. A method of providing digital rights management of content, the method comprising:
sending an authentication challenge randomly identifying at least a portion of content stored in memory of a client;
receiving an authentication code generated based upon the content identified by the authentication challenge; and
authenticating the client based upon the authentication code.

22. A method according to claim 21, wherein sending an authentication challenge comprises sending an authentication challenge randomly identifying at least one location in memory of a client, and
wherein receiving an authentication code comprises receiving an authentication code generated based upon the content stored at the identified locations in memory of the client.

23. A method according to claim 22 further comprising:
mapping at least a portion of the content stored in memory of a known-authorized client, the mapped content being associated with at least one location in memory of the known-authorized client where the content is stored; and
generating a comparison code based upon the mapped content stored at the identified locations in memory of the known-authorized client,
wherein authenticating the client comprises authenticating the client based upon a comparison of the authentication code and the comparison code.

24. A method according to claim 23, wherein receiving an authentication code comprises receiving an authentication code generated by hashing the content stored at the identified locations in memory of the client,
wherein generating a comparison code comprises hashing the mapped content stored at the identified locations in memory of the known-authorized client.

25. A method according to claim 21, wherein sending an authentication challenge, receiving an authentication code and authenticating the client occur at a plurality of instances, and wherein the content identified by the authentication challenge in at least one instance differs from the content identified by the authentication challenge in at least one other instance.

26. A method according to claim 21 for providing digital rights management of an access-controlled application stored in memory of the client, wherein sending an authentication challenge comprises sending an authentication challenge randomly identifying at least a portion of a read-only memory (ROM) of the client and at least a portion of the access-controlled application stored in memory of the client.

27. A method according to claim 21 for providing digital rights management of an access-controlled application adapted to interact with a network entity, wherein authenticating the client comprises authenticating the client such that the client is thereafter permitted to operate the access-controlled application to interact with the network entity when the client is authenticated, and otherwise prevented from operating the access-controlled application to interact with the network entity.

28. A computer program product for providing digital rights management of content, wherein the computer program product comprises at least one computer-readable storage medium having computer-readable program code portions stored therein, the computer-readable program code portions comprising:
a first executable portion for receiving an authentication challenge randomly identifying at least a portion of content stored in memory of a client; and
a second executable portion for generating an authentication code based upon the content identified by the authentication challenge such that the client can thereafter be authenticated based upon the authentication code.

29. A computer program product according to claim 28, wherein the first executable portion is adapted to receive an authentication challenge randomly identifying at least one location in memory of a client, and
wherein the second executable portion is adapted to generate an authentication code based upon the content stored at the identified locations in memory of the client.

30. A computer program product according to claim 28, wherein the first and second executable portions are adapted to receive an authentication challenge and generate an authentication code at a plurality of instances, and wherein the content identified by the authentication challenge in at least one instance differs from the content identified by the authentication challenge in at least one other instance.

31. A computer program product according to claim 28 for providing digital rights management of an access-controlled application stored in memory of the client, wherein the first executable portion is adapted to receive an authentication challenge randomly identifying at least a portion of a read-only memory (ROM) of the client and at least a portion of the access-controlled application stored in memory of the client.

32. A computer program product according to claim 28 for providing digital rights management of an access-controlled application adapted to interact with a network entity, wherein the computer program product further comprises:
a third executable portion for operating the access-controlled application to interact with the network entity when the client is authenticated.

33. A computer program product for providing digital rights management of content, wherein the computer program product comprises at least one computer-readable storage medium having computer-readable program code portions stored therein, the computer-readable program code portions comprising:
a first executable portion for sending an authentication challenge randomly identifying at least a portion of content stored in memory of a client;
a second executable portion for receiving an authentication code generated based upon the content identified by the authentication challenge; and
a third executable portion for authenticating the client based upon the authentication code.

34. A computer program product according to claim 33, wherein the first executable portion is adapted to send an authentication challenge randomly identifying at least one location in memory of a client, and
wherein the second executable portion is adapted to receive an authentication code generated based upon the content stored at the identified locations in memory of the client.

35. A computer program product according to claim 34 further comprising:
a fourth executable portion for mapping at least a portion of the content stored in memory of a known-authorized client, the mapped content being associated with at least one location in memory of the known-authorized client where the content is stored; and
a fifth executable portion for generating a comparison code based upon the mapped content stored at the identified locations in memory of the known-authorized client,
wherein the third executable portion is adapted to authenticate the client based upon a comparison of the authentication code and the comparison code.

36. A computer program product according to claim 35, wherein the second executable portion is adapted to receive an authentication code generated by hashing the content stored at the identified locations in memory of the client,
wherein the fifth executable portion is adapted to generating a comparison code by hashing the mapped content stored at the identified locations in memory of the known-authorized client.

37. A computer program product according to claim 33, wherein the first, second and third executable portions are adapted to send an authentication challenge, receive an authentication code and authenticate the client at a plurality of instances, and wherein the content identified by the authentication challenge in at least one instance differs from the content identified by the authentication challenge in at least one other instance.

38. A computer program product according to claim 33 for providing digital rights management of an access-controlled application stored in memory of the client, wherein the first executable portion is adapted to send an authentication challenge randomly identifying at least a portion of a read-only memory (ROM) of the client and at least a portion of the access-controlled application stored in memory of the client.

39. A computer program product according to claim 33 for providing digital rights management of an access-controlled application adapted to interact with a network entity, wherein the third executable portion is adapted to authenticate the client such that the client is thereafter permitted to operate the access-controlled application to interact with the network entity when the client is authenticated, and otherwise prevented from operating the access-controlled application to interact with the network entity.
